(19) United States
(12) Patent Application Publication
(10) Pub. No.: US 2004/0165865 A1
(43) Pub. Date: Aug. 26, 2004

(54) Method and apparatus for recording/reproducing graphic and subtitle data on/from a high-density recording medium

(76) Inventors: Kang Soo Seo, Kyunggi-do (KR); Byung Jin Kim, Kyunggi-do (KR); Chang Bum Kim, Seoul (KR)

Correspondence Address: HARNESS, DICKEY & PIERCE, P.L.C., P.O. BOX 8910, RESTON, VA, 20195, US

(21) Appl. No.: 10/786,923

(22) Filed: Feb. 25, 2004

(30) Foreign Application Priority Data
Feb. 25, 2003 (KR) 10-2003-0011719

(51) Int. Cl. H04N 5/781

(52) U.S. Cl. 386/95; 386/125

(57) ABSTRACT

A method and apparatus for recording additional data such as graphic and subtitle data to be overlaid on a main video on a high-density recording medium and for reproducing the recorded additional data is disclosed. The method and apparatus in accordance with the present invention receives video data and additional data including graphic data and/or subtitle data and records the additional data as a plurality of streams on the recording medium by dividing and organizing the additional data in such a way that the additional data is included in a plurality of regions that will be overlaid on a video image constructed from the video data.

### FOREIGN PRIORITY

The present invention claims priority under 35 U.S.C. 119 on Korean Application No. 10-2003-011719 filed Feb. 25, 2003; the contents of which are incorporated by reference in their entirety.

### BACKGROUND OF THE INVENTION

1. Field of the Invention

The present invention relates to a method and apparatus for recording additional data such as graphic and subtitle data to be overlaid on a main video on a high-density recording medium and for reproducing the recorded additional data.

2. Description of the Related Art

The standardization of new high-density optical disks capable of recording large amounts of digital TV broadcast contents containing high-quality video and audio data has been progressing rapidly and new optical disk related products are expected to be commercially available on the market in the near future. The Blu-ray Disc Rewritable (called ‘BD-RE’ in general) is one example of these new optical disks.

The standardization for a high-density read-only optical disk such as a Blu-ray Disc ROM disk (called ‘BDROM’) is also under way. A BD-ROM requires user interfacing data for reproduction control of video contents recorded thereon.

By the way, user interfacing needs text data and/or graphic data such as buttons and button function descriptive images for user's easy operation. Furthermore, text and/or graphic data of large size is also required to provide additional information about main video.

A method for recording graphic data and/or subtitle data on a high-density recording medium in such a way that the graphic and/or subtitle data can be easily overlaid on a main image, while the data occupies less space in the recording medium, is not yet available.

### SUMMARY OF THE INVENTION

It is an object of the present invention to a method and apparatus for recording additional data such as text and/or graphic data on a recording medium by organizing the additional data according to regions in which the additional data will be displayed.

It is another object of the present invention to provide a method and apparatus for reproducing additional data recorded along with main video data on a recording medium in accordance with the present invention.

The method for recording graphic/subtitle data on a recording medium in accordance with one embodiment of the present invention comprises the steps of receiving video data and additional data including graphic data and/or subtitle data and recording the additional data on the recording medium by dividing and organizing the additional data in such a way that the additional data is included in a plurality of regions that will be overlaid on a video image constructed from the video data.

The method for recording graphic/subtitle data on a recording medium in accordance with another embodiment of the present invention comprises the steps of receiving video data and additional data including graphic data and/or subtitle data and recording the additional data as a plurality of individual streams on the recording medium.

The method for reproducing a recording medium in accordance with one embodiment of the present invention comprises the steps of reproducing video data and additional data including graphic data and/or subtitle data recorded on the recording medium, decoding the reproduced video data to construct a main plane and decoding the additional data to construct a plurality of planes including presentation regions, and constructing a video image by mixing the main plane with the plurality of planes and outputting the constructed video image.

### BRIEF DESCRIPTION OF THE DRAWINGS

The above features and other advantages of the present invention will be more clearly understood from the following detailed description taken in conjunction with the accompanying drawings, in which:

FIG. 1 illustrates an exemplary embodiment of a recording medium file or data structure according to the present invention;

FIG. 2 illustrates an example of a recording medium having the data structure of FIG. 1 stored thereon;

FIG. 3 illustrates a diagram of the structure of an optical disc recording/reproducing apparatus where a method for reproducing/recording a multi-path data stream according to the present invention is embodied;

FIG. 4 illustrates an example of a plurality of regions on a video page in which graphic and subtitle data will be organized in accordance with the present invention;

FIGS. 5a-5c illustrate exemplary embodiments in which additional data such as graphic and subtitle data is recorded as a plurality of streams in accordance with the present invention;

FIG. 6 illustrates a detailed block diagram of the AV/Graphic decoder of FIG. 3; and

FIG. 7 illustrates an example of constructing a video image including graphic and subtitle data in accordance with the present invention.

### DETAILED DESCRIPTION OF THE PREFERRED EMBODIMENTS

In order that the invention may be fully understood, preferred embodiments thereof will now be described with reference to the accompanying drawings.

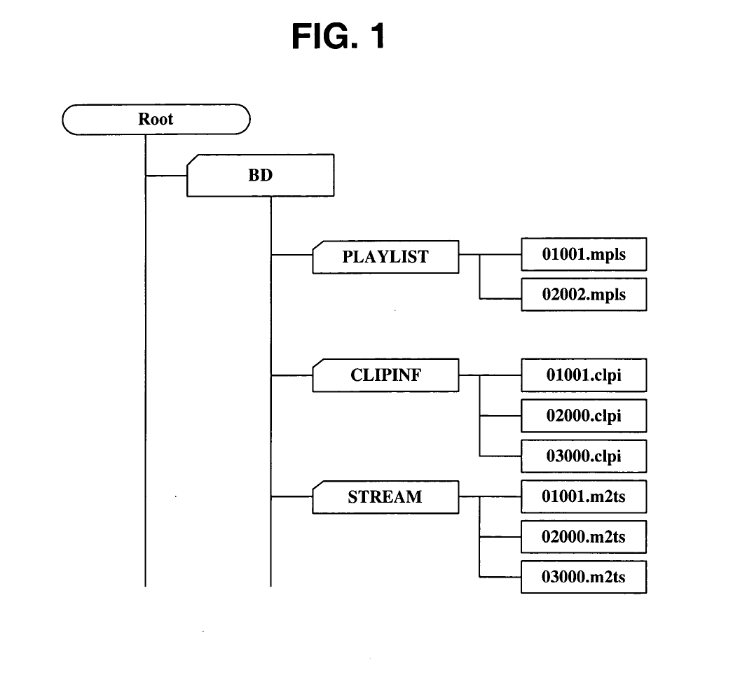

A high-density optical disk, for example, a Blu-Ray ROM (BD-ROM) disk, BD-RE disk, etc. in accordance with the invention may have a file or data structure for managing reproduction of video and audio data as shown in FIG. 1. Some aspects of the data structure according to the present invention shown in FIG. 1 are the same as the well-known BD-RE standard, as such these aspects will not be described in great detail.

As shown in FIG. 1, the root directory contains at least one BD directory. The BD directory includes general files (not shown), a PLAYLIST directory in which playlist files (e.g.,*.mpls) are stored, a CLIPINF directory in which clip information files (*.clpi) are stored, and a STREAM directory in which MPEG2-formatted A/V stream clip files (*.m2ts), corresponding to the clip information files, are stored.

The STREAM directory includes MPEG2-formatted single-path and/or multi-path A/V stream files that are called clips or clip files. The A/V stream includes source packets of video and audio.

For example, a source packet of video data includes a header and a transport packet. In addition, a source packet includes a source packet number, which is generally a sequentially assigned number that serves as an address for accessing the source packet. Transport packets include a packet identifier (PID). The PID identifies the sequence of transport packets to which a transport packet belongs. Each transport packet in the sequence will have the same PID.

The CLIPINF directory includes a clip information file associated with each A/V stream file. The clip information file indicates, among other things, the type of A/V stream associated therewith, sequence information, program information, and timing information.

The PLAYLIST directory includes one or more playlist files. The concept of a playlist has been introduced to promote ease of editing/assembling clips for playback. A playlist file is a collection of playing intervals in the clips. Each playing interval is referred to as a playitem. The playlist file, among other things, identifies each playitem forming the playlist, and each playitem, among other things, is a pair of IN-point and OUT-point that point to positions on a time axis of the clip (e.g., presentation time stamps on an ATC or STC basis).

Expressed another way, the playlist file identifies playitems, each playitem points to a clip or portion thereof and identifies the clip information file associated with the clip. The clip information file is used, among other things, to map the playitems to the clip of source packets.

The general files (not shown) provide general information for managing the reproduction of the A/V streams recorded on the optical disk.

In addition to illustrating the data structure of the recording medium according to an embodiment of the present invention, FIG. 1 represents the areas of the recording medium. For example, the general information files are recorded in one or more general information areas, the playlist directory is recorded in one or more playlist directory areas, each playlist in a playlist directory is recorded in one or more playlist areas of the recording medium, etc.

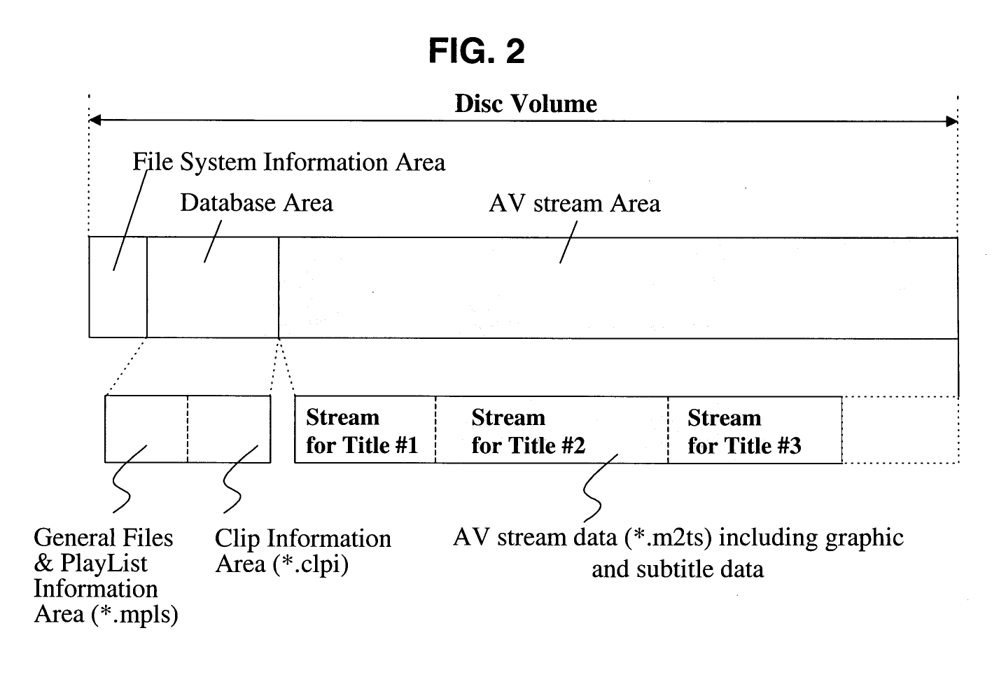

FIG. 2 illustrates an example of a recording medium having the data structure of FIG. 1 stored thereon. As shown, the recording medium includes a file system information area, a data base area, and an A/V stream area.

The data base area includes a general information file and playlist information area and a clip information area. The general information file and playlist information area have the general information files recorded in a general information file area thereof, and the PLAYLIST directory and playlist files recorded in a playlist information area thereof. The clip information area has the CLIPINF directory and associated clip information files recorded therein. The A/V stream area has A/V streams and graphic data for the various titles recorded therein.

Video and audio data are typically organized as individual titles; for example, different movies represented by the video and audio data are organized as different titles. Furthermore, a title may be organized into individual chapters in much the same way a book is often organized into chapters.

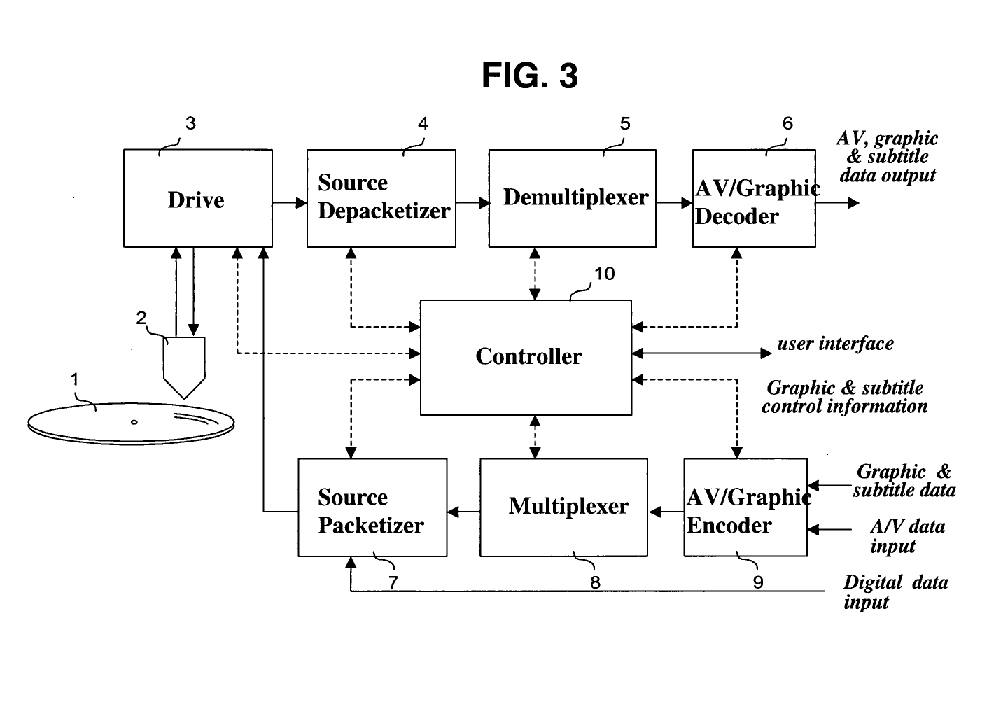

FIG. 3 illustrates a schematic diagram of an embodiment of an optical disk recording and reproducing apparatus according to the present invention. As shown, an AV/Graphic encoder 9 receives and encodes data (e.g., movie video and audio data, additional data such as subtitle data and bitmap-formatted graphic images, and their positions, colors and display effect control information, etc.) into PES packets. The AV/Graphic encoder 9 outputs the encoded data along with coding information and stream attribute information. A multiplexer 8 multiplexes the encoded data based on the coding information and stream attribute information to create, for example, an MPEG-2 transport stream. A source packetizer 7 packetizes the transport packets from the multiplexer 8 into source packets in accordance with the audio/video/graphic format of the optical disk.

The above-mentioned control information about positions, colors and display effects of subtitles and/or graphic images may be entered through user's inputs to a controller 10 and then delivered to the AV/Graphic encoder 9.

As shown in FIG. 3, the operations of the AV/Graphic encoder 9, the multiplexer 8 and the source packetizer 7 are controlled by the controller 10. The controller 10 receives user input on the recording operation, and provides control information to AV/Graphic encoder 9, multiplexer 8 and the source packetizer 7.

For example, the controller 10 instructs the AV/Graphic encoder 9 on the type of encoding to perform, instructs the multiplexer 8 on the transport stream to create, and instructs the source packetizer 7 on the source packet format. The controller 10 further controls a drive 3 to record on the optical disk the output from the source packetizer 7 as a single clip file.

The single clip file includes video and audio data and subtitle and graphic data that are recorded in respective streams in the form of TS.

The controller 10 also creates the navigation and management information for managing reproduction of the data being recorded on the optical disk. For example, based on information received via the user interface (e.g., instruction set saved on disk, provided over an intranet or internet by a computer system, etc.) the controller 10 controls the drive 3 to record one or more of the data structures of FIGS. 1 and 2 on the optical disk.

During reproduction, the controller 10 controls the drive 3 to reproduce this data structure. Based on the information contained therein, as well as user input received over the user interface (e.g., control buttons on the recording and reproducing apparatus or a remote associated with the apparatus), the controller 10 controls the drive 3 to reproduce the data from the optical disk.

For example, as mentioned above with respect to the embodiments of the present invention, an A/V and additional data stream included in a single clip file is reproduced based on the navigation information.

The reproduced source packets of an A/V stream and additional data stream are received by a source depacketizer 4 and converted into appropriate data stream (e.g., an MPEG-2 transport packet stream). A demultiplexer 5 demultiplexes the respective data streams into PES packet-encoded data of video and audio, subtitle and graphic data. An AV/Graphic decoder 6 decodes the encoded data encapsulated in PES packets to produce the original data that was fed to the AV/Graphic encoder 9 or to produce video with which subtitles and/or graphic images are sometimes overlapped.

During reproduction, the controller 10 controls the operation of the source depacketizer 4, demultiplexer 5 and AV/Graphic decoder 6. The controller 10 receives user input on the reproducing operation, and provides control information to AV/Graphic decoder 6, demultiplexer 5 and the source depacketizer 4. For example, the controller 10 instructs the AV/Graphic decoder 9 on the type of decoding to perform, instructs the demultiplexer 5 on the transport stream to demultiplex, and instructs the source depacketizer 4 on the source packet format.

While FIG. 3 has been described as a recording and reproducing apparatus, it will be understood that only a recording or only a reproducing apparatus may be provided using those portions of FIG. 3 providing the recording or reproducing function.

The embodiments to organize the additional data into respective streams are described hereinafter.

The organization of additional data for recording is made by main operation of the controller 10 in cooperation with the AV/Graphic encoder 9. However, the AV/Graphic encoder 9 can organize a PES packet by itself if necessary information for display control related with inputted graphic images is directly received.

In the case of a read-only BD-ROM disk, the data constructed in accordance with the embodiments of the present invention is recorded thereon as pre-pits when the disk is manufactured.

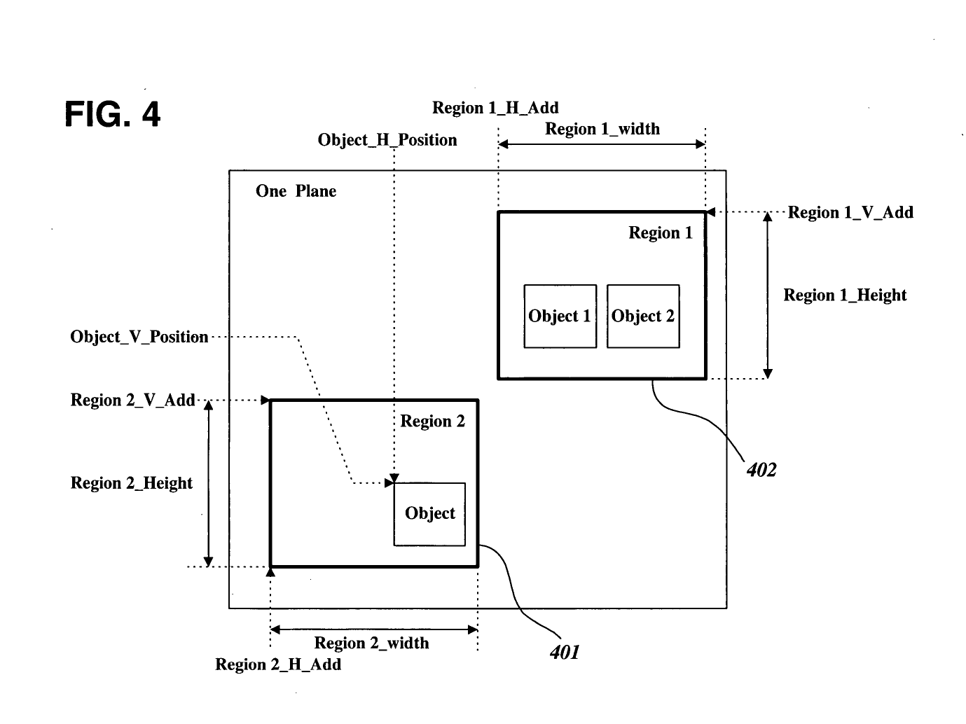

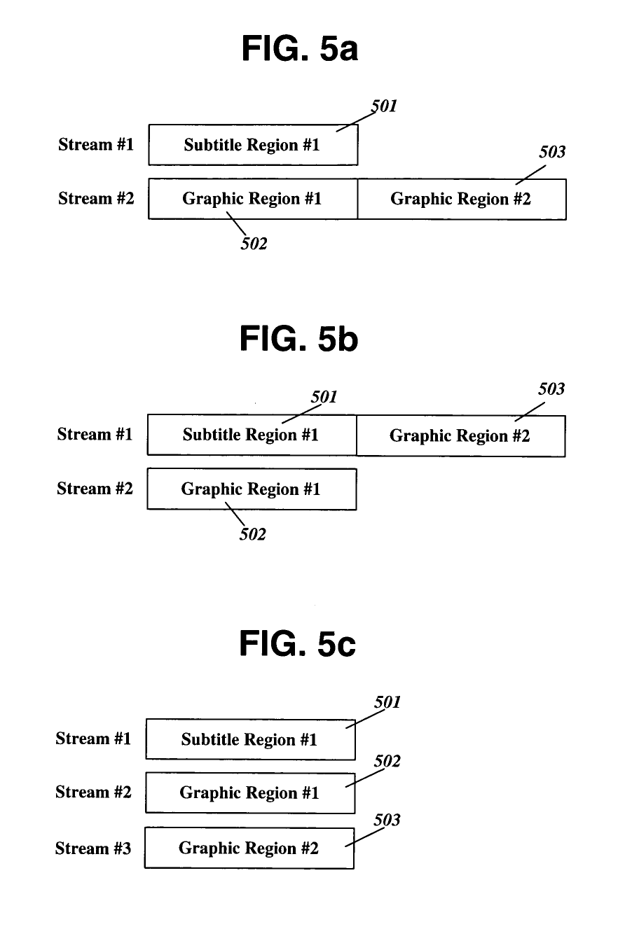

Subtitle data and/or graphic data associated with one main video page (or plane) is organized into regions by the controller 10 based on the positions where the subtitle data and/or graphic data is to be displayed. In FIG. 4, for example, the additional data is organized into two regions 401 and 402 to be overlaid on a main video plane 400. If more than one region exists, the regions may overlap with each other. As shown in FIGS. 5a-5c, the subtitle data and/or graphic data associated with each region is recorded separately on a region basis.

Each region includes at leas one object, which is graphic data and/or subtitle data. One region may comprise one object or foreground objects (text, icon, graphic item, image, etc) and background objects (background box).

One object may be subtitle data, an icon in a selection menu for a user, or graphic data for a background image. Similarly, the object may be an inverted or highlighted icon to be displayed when a user selects a menu icon.

FIGS. 5a-5c illustrate exemplary streams in which additional data associated with multiple regions is recorded. The additional data is recorded as multiple streams so that subtitle data and graphic data can be simultaneously displayed on a main video plane.

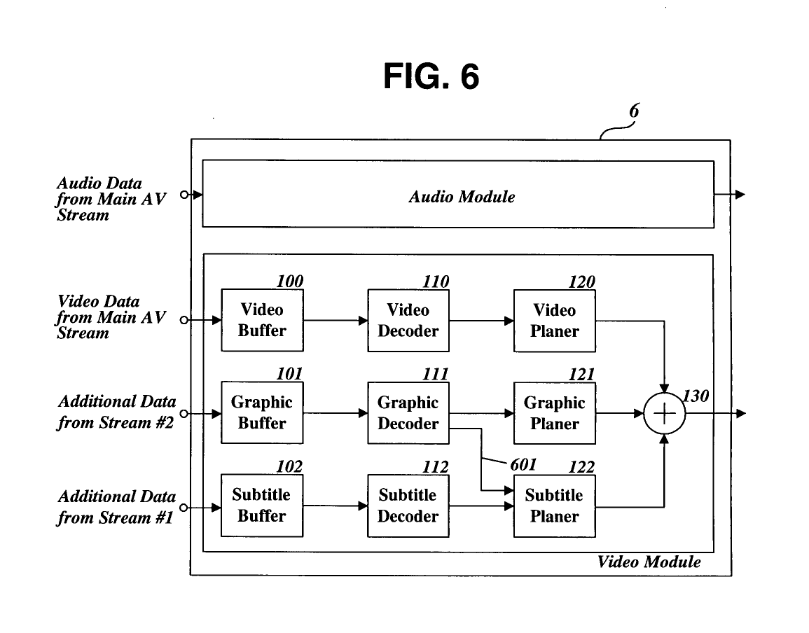

As shown in FIG. 6, the AV/Graphic decoder 6 of FIG. 3 comprises a video decoder 110, a graphic decoder 111, a subtitle decoder 112 and therefore graphic data and subtitle data can be decoded simultaneously, which explains the reason the graphic data and subtitle data are recorded not sequentially but in parallel.

In FIGS. 5a and 5b, under the condition that there are two graphic decoders (one graphic decoder and one subtitle decoder), the additional data is recorded as two streams. As described above, the data is organized in each stream on a region basis, which implies that the data associated with each region is separated not only physically (e.g., position) but also logically (e.g., FAT (File Allocation Table)).

In some cases, more than two graphic regions are displayed on one main video plane. In FIGS. 5a-5c, two graphic regions 502 and 503 are overlaid on the same main video plane. In this case, graphic region #2 data (503) is placed after subtitle region #1 data (501) of stream #1 or graphic region #2 data (502) of stream #2 so that graphic region #2 data (503) can be decoded right after subtitle region #1 data (501) and graphic region #2 data (502) are decoded simultaneously.

In FIG. 5b, graphic data and subtitle data are placed in the same stream (stream #1), which is allowed because the subtitle decoder 112 can decode the graphic data.

If the decoder 6 of the recording/reproduction apparatus includes three graphic decoders including a subtitle decoder, the graphic region #2 data (503) is recorded as an individual stream. FIG. 5c exemplifies additional data recorded as three streams, in which case subtitle region #1 data of stream #1, graphic region #1 data of stream #2, and graphic region #2 data of stream #3 are decoded simultaneously.

The text, icons, and/or image objects outputted by the graphic decoder 111 and subtitle decoder 112 are placed at predetermined positions on a video plane by following graphic and subtitle planers 121 and 122 so that they can be overlaid on the video picture (plane) outputted by the video planer 120. The position information of each object, which is included in each region data, is provided to the corresponding planer when the object is decoded.

The AV/Graphic decoder 6 of FIG. 6 has two graphic decoders (including a subtitle decoder). In this case, graphic region data and subtitle region data decoded simultaneously forms one plane (e.g., subtitle plane) and the graphic region data decoded subsequently forms another plane (e.g., graphic plane). To this end, the output of the graphic decoder 111 is fed to the subtitle planer 122 as well as the graphic planer 121. The subtitle plane, therefore, includes not only subtitle but graphic items. Similarly, the output of the subtitle decoder 112 may be fed to the graphic planer 121.

The graphic plane and subtitle plane from the graphic planer 121 and subtitle planer 122 are mixed with the video plane from the video planer 120 by a mixer 120 to form one video page.

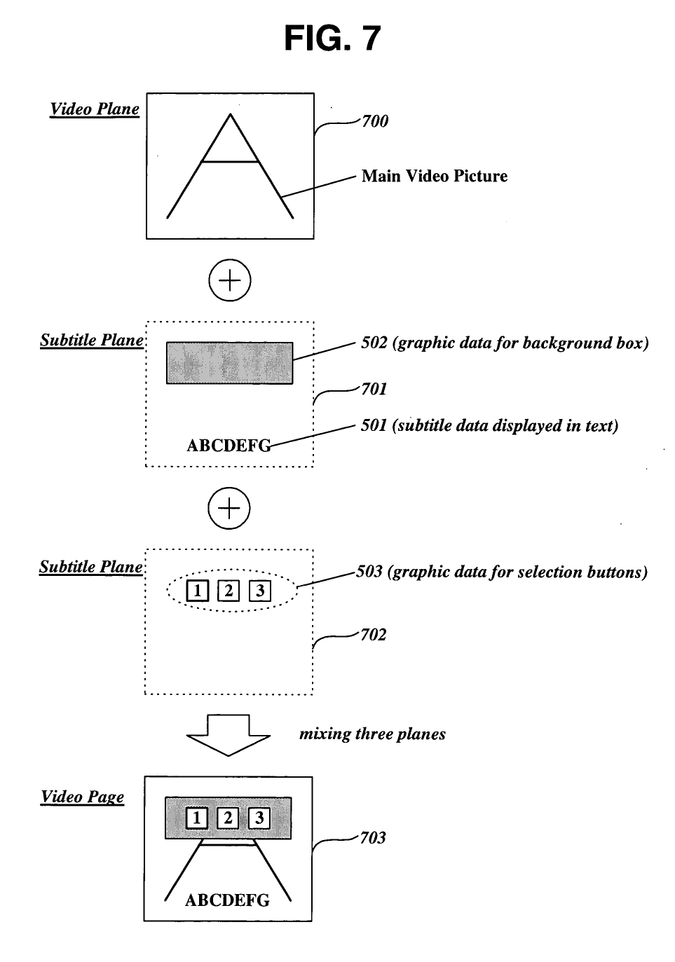

FIG. 7 illustrates an example wherein one video page is formed from graphic and subtitle region data shown in FIG. 5a by the aforementioned procedure, which will now be described in detail.

When a particular clip file is selected and reproduced from a recording medium, a video stream, stream #1, and stream #2 included in the clip file are stored in a video buffer 100, a subtitle buffer 102, and a graphic buffer 101, respectively. The stored streams are decoded by the following respective decoders 110, 111, and 112.

The subtitle region #1 data (501) of Stream #1 and graphic region #1 data of stream #2 are decoded simultaneously and provided to the subtitle planer 122 to form a subtitle plane 701.

Right after decoding graphic region #1 data (502), the graphic decoder 111 decodes graphic region #2 data (503) of stream #2 and the decoded data is provided to the graphic planer 121 to form a graphic plane 702.

The two additional data planes 701 and 702 are mixed with the main video plane 700 from the video planer 120 to form one video page 703.

While the video page 703 is displayed on an external displaying apparatus (e.g., digital TV), a user can activate a function that he/she wants by selecting a selection menu button (e.g., graphic region #2 object (503)).

The method and apparatus for recording graphic/subtitle data on a high-density recording medium in accordance with the present invention reduces the size of additional data such as text, icons, or images by efficiently storing the additional data and improves the speed of overlaying the additional data on the main video by recording the additional data as multiple streams and simultaneously decoding the multiple streams using multiple decoders.

While the invention has been disclosed with respect to a limited number of embodiments, those skilled in the art, having the benefit of this disclosure, will appreciate numerous modifications and variations therefrom. It is intended that all such modifications and variations fall within the spirit and scope of the invention.

What is claimed is:

1. A method for recording graphic/subtitle data on a recording medium, comprising the steps of:
receiving video data and additional data including graphic data and/or subtitle data; and
recording the additional data on the recording medium by dividing and organizing the additional data in such a way that the additional data is included in a plurality of regions that will be overlaid on a video image constructed from the video data.

2. The method set forth in claim 1, wherein the graphic data and subtitle data are organized into distinct regions.

3. The method set forth in claim 1, wherein the plurality of regions do not overlap with each other on the video image.

4. The method set forth in claim 1, wherein each of the plurality of regions includes at least one object.

5. The method set forth in claim 4, wherein the object is text, an icon, an image, or a background box.

6. A method for recording graphic/subtitle data on a recording medium, comprising the steps of:
receiving video data and additional data including graphic data and/or subtitle data; and
recording the additional data as a plurality of individual streams on the recording medium.

7. The method set forth in claim 6, wherein the number of the plurality of streams is the same as the number of graphic decoders contained in a reproducing apparatus.

8. The method set forth in claim 6, wherein parts of the additional data that should be simultaneously decoded are placed in distinct streams.

9. A high-density recording medium having video data and additional data including graphic data and/or subtitle data, wherein the additional data is divided and organized in such a way that the additional data is included in a plurality of regions that will be overlaid on a video image constructed from the video data.

10. The high-density recording medium set forth in claim 9, wherein the graphic data and subtitle data are organized into distinct regions.

11. A high-density recording medium having video data and additional data including graphic data and/or subtitle data, wherein the additional data is recorded as a plurality of individual streams.

12. The high-density recording medium set forth in claim 11, wherein parts of the additional data that should be simultaneously decoded are placed in distinct streams.

13. An apparatus for recording graphic/subtitle data on a recording medium, comprising:
first means for receiving video data and additional data including graphic data and/or subtitle data;
second means for dividing and organizing the additional data in such a way that the additional data is included in a plurality of regions that will be overlaid on a video image constructed from the video data; and
third means for recording the additional data and the video data on the recording medium.

14. The apparatus set forth in claim 13, wherein the second means places the graphic data and subtitle data in distinct regions.

15. An apparatus for recording graphic/subtitle data on a recording medium, comprising:
first means for receiving video data and additional data including graphic data and/or subtitle data;
second means for organizing the additional data as a plurality of individual streams; and
third means for recording the additional data and the video data on the recording medium.

16. The apparatus set forth in claim 15, wherein the number of streams organized by the second means is the same as the number of graphic decoders included in the apparatus.

17. The apparatus set forth in claim 15, wherein the second means places parts of the additional data that should be simultaneously decoded in distinct streams.

18. A method for reproducing a recording medium, comprising the steps of:
reproducing video data and additional data including graphic data and/or subtitle data recorded on the recording medium;
decoding the reproduced video data to construct a main plane and decoding the additional data to construct a plurality of planes including presentation regions; and
constructing a video image by mixing the main plane with the plurality of planes and outputting the constructed video image.

19. The method set forth in claim 18, wherein the plurality of planes include a subtitle plane and a graphic plane.

20. The method set forth in claim 19, wherein the subtitle plane includes decoded graphic data as well as decoded subtitle data.

21. An apparatus for reproducing a recording medium, comprising:
first means for reproducing video data and additional data including graphic data and/or subtitle data recorded on the recording medium;
second means for decoding the reproduced video data to construct a main plane and decoding the additional data to construct a plurality of planes including presentation regions; and
third means for constructing a video image by mixing the main plane with the plurality of planes and outputting the constructed video image.

22. The apparatus set forth in claim 21, wherein the second means organizes the additional data into a subtitle plane and a graphic plane.

23. The apparatus set forth in claim 22, wherein the second means organizes the subtitle plane such that the subtitle plane includes decoded graphic data as well as decoded subtitle data.
